(19) United States
(12) Patent Application Publication
(10) Pub. No.: US 2011/0236752 A1
(43) Pub. Date: Sep. 29, 2011

(54) POWER STORAGE DEVICE

(75) Inventors: Takahiro KAWAKAMI, Atsugi (JP); Masaki YAMAKAJI, Atsugi (JP); Nadine TAKAHASHI, Yamato (JP)

(73) Assignee: SEMICONDUCTOR ENERGY LABORATORY CO., LTD., Atsugi-shi (JP)

(21) Appl. No.: 13/052,746

(22) Filed: Mar. 21, 2011

(30) Foreign Application Priority Data
Mar. 26, 2010 (JP) 2010-073404
Mar. 26, 2010 (JP) 2010-073727

(51) Int. Cl. H01M 4/58; H01M 4/36; H01M 10/056; H01B 1/02

(52) U.S. Cl. 429/188; 429/221; 252/519.14

(57) ABSTRACT

A power storage device includes a positive electrode including a positive electrode current collector and a positive electrode active material having an olivine structure which is represented by a structural formula LiFeₓMe₁₋ₓPO₄ (Me=Mn, Ni, or Co) (x is greater than 0 and less than 1) over the positive electrode current collector, or a power storage device includes a positive electrode including a positive electrode current collector and a positive electrode active material, and a negative electrode which faces the positive electrode through an electrolyte, where discharging capacitance is greater than or equal to 150 mAh/g and energy density per unit weight is higher than or equal to 500 mWh/g.

### TECHNICAL FIELD

One embodiment of the invention disclosed herein relates to a power storage device.

### BACKGROUND ART

The field of portable electronic devices such as personal computers and cellular phones has progressed significantly. The portable electronic device needs a chargeable power storage device having high energy density, which is small, lightweight, and reliable. As such a power storage device, for example, a lithium-ion secondary battery is known. In addition, development of electrically propelled vehicles on which secondary batteries are mounted has also been progressing rapidly from a rise of growing awareness to environmental problems and energy problems.

As a positive electrode material of a lithium-ion secondary battery, a material which can supply lithium stably has been developing.

For example, as a lithium supply source, a phosphate compound having an olivine structure, which contains lithium and iron (Fe) or cobalt (Co), such as lithium iron phosphate (LiFePO₄) or lithium cobalt phosphate (LiCoPO₄), is known (see Patent Document 1 and Non-Patent Document 1).

### REFERENCE

### Patent Document

[Patent Document 1] Japanese Published Patent Application No. H11-25983
[Non-Patent Document 1] Byoungwoo Kang, Gerbrand Deder, Nature, Vol. 458 (12), pp. 190-193 (2009)

### DISCLOSURE OF INVENTION

The above phosphate compound having an olivine structure, which contains lithium and iron (Fe) or cobalt (Co), is a stable lithium supply source.

In particular, a lithium-ion secondary battery in which lithium iron phosphate (LiFePO₄) is used as a positive electrode active material has a stable structure even charging and discharging is performed and has high safety. Further, the lithium-ion secondary battery in which lithium iron phosphate (LiFePO₄) is used as a positive electrode active material has an advantage of high capacitance.

However, such a stable lithium-ion secondary battery in which lithium iron phosphate (LiFePO₄) which is a lithium supply source is used as a positive electrode active material has a disadvantage in that output energy has low energy density.

In view of the above problem, an object of one embodiment of the invention disclosed herein is to obtain a power storage device with high discharging capacitance and high energy density.

One embodiment of the invention disclosed herein is lithium iron phosphate having an olivine structure, in which metal atoms having higher oxidation-reduction potential than iron are substituted for part of the iron atoms and is used as a positive electrode active material.

In addition, another embodiment of the invention disclosed herein is a power storage device having the positive electrode active material.

As the metal atom having high oxidation-reduction potential than an iron atom, manganese, cobalt, nickel, or the like is typically used.

In other words, the positive electrode active material according to one embodiment of the present invention is a compound represented by a structural formula LiFeₓMe₁₋ₓPO₄. In the structural formula LiFeₓMe₁₋ₓPO₄, x is preferably greater than 0 and less than 1, more preferably greater than or equal to 0.2 and less than or equal to 0.8, or much more preferably greater than or equal to 0.3 and less than or equal to 0.5.

The lithium iron phosphate having an olivine structure has high conductivity; thus, capacitance is high. However, the energy density is low.

However, a phosphate compound containing lithium, iron, and a metal Me having higher oxidation-reduction potential than iron is used as a positive electrode active material, whereby oxidation-reduction reaction of the metal Me as well as oxidation-reduction reaction of an iron atom is generated in charging and discharging of a lithium-ion secondary battery; therefore, high discharging capacitance as well as high discharging voltage and high energy density can be obtained.

As described above, a positive electrode active material with high discharging capacitance and high energy density can be obtained. Further, by obtainment of such a positive electrode active material, a power storage device with high discharging capacitance, high discharging voltage, and high energy density can be obtained.

More specifically, by obtainment of such a positive electrode active material, a power storage device whose discharging capacitance is high, which is greater than or equal to 150 mAh/g, discharging voltage is high, and energy density is high, which is greater than 500 mWh/g, can be obtained.

One embodiment of the invention disclosed herein relates to a power storage device which includes a positive electrode including a positive electrode active material having an olivine structure which is represented by a structural formula LiFeₓMe₁₋ₓPO₄ (Me=Mn, Ni, or Co) (x is greater than 0 and less than 1) and which has conductivity of greater than or equal to 1×10⁻⁹ S/cm and less than or equal to 6×10⁻⁹ S/cm.

Another embodiment of the invention disclosed herein relates to a power storage device which includes a positive electrode current collector; a positive electrode including a positive electrode active material having an olivine structure which is represented by a structural formula LiFeₓMe₁₋ₓPO₄ (Me=Mn, Ni, or Co) (x is greater than 0 and less than 1) and which has conductivity of greater than or equal to 1×10⁻⁹ S/cm and less than or equal to 6×10⁻⁹ S/cm, over the positive electrode current collector; and a negative electrode which faces the positive electrode through an electrolyte.

The positive electrode active material has discharging capacitance of greater than or equal to 150 mAh/g and energy density per unit weight of higher than or equal to 550 mWh/g.

Another embodiment of the invention disclosed herein is a power storage device which includes a positive electrode current collector; a positive electrode including a positive electrode active material, over the positive electrode current collector; and a negative electrode which faces the positive electrode through an electrolyte, where in lithium iron phosphate having an olivine structure, metal atoms having higher oxidation-reduction potential than iron is substituted for part of the iron atoms and is used as a positive electrode active material, so that discharging capacitance of greater than or equal to 150 mAh/g and energy density of higher than 500 mWh/g can be obtained.

The negative electrode contains one or more of graphite, silicon, and aluminum.

The electrolyte is an electrolyte solution containing lithium ions.

According to one embodiment of the invention disclosed herein, a power storage device having high capacitance, high discharging voltage, and high energy density can be obtained.

### BRIEF DESCRIPTION OF DRAWINGS

FIG. 1 is a cross-sectional view of a power storage device.

FIG. 2 is a graph showing results of XRD diffraction.

FIG. 3 is a graph showing charging and discharging characteristics of a power storage device,

FIG. 4 is a graph showing discharging characteristics of a power storage device.

FIG. 5 is a graph showing conductivity of an iron phosphate compound.

FIG. 6 is a graph showing energy density of a power storage device.

### BEST MODE FOR CARRYING OUT THE INVENTION

Hereinafter, embodiments of the present invention will be described with reference to the drawings. However, the present invention is not limited to the following description. It is easily understood by those skilled in the art that the mode and detail can be changed in various ways unless departing from the scope and spirit of the present invention. Therefore, unless such changes and modifications depart from the scope of the present invention, they should be construed as being included therein. Note that reference numerals denoting the same portions are commonly used in different drawings.

Note that the size, the thickness of a layer, and a region of each structure illustrated in the drawings and the like in the embodiments are exaggerated for simplicity in some cases. Therefore, embodiments of the present invention are not limited to such scales.

Note that terms with ordinal numbers such as “first”, “second”, and “third” in this specification are used in order to identify components, and the terms do not limit the components numerically.

In this embodiment, as a positive electrode active material of a power storage device, an iron phosphate compound having an olivine structure, which contains lithium and a metal Me, which is represented by a structural formula LiFeₓMe₁₋ₓPO₄ ((Me is Mn, Ni, or Co) (x is greater than 0 and less than 1)), is used. Note that in this specification, in some cases, the iron phosphate compound having an olivine structure, which contains lithium and a metal Me, is simply referred to as a “iron phosphate compound”.

The iron phosphate compound contains lithium (Li), iron (Fe), and phosphate (PO₄), and, as the metal Me, any one of elements of manganese (Mn), nickel (Ni), and cobalt (Co), which are metal atoms each having higher oxidation-reduction potential than iron, is included. In addition, the iron phosphate compound is a solid solution in which part of a ligand of an iron atom of lithium iron phosphate having an olivine structure is an atom of the metal Me. In a structural formula LiFeₓMe₁₋ₓPO₄ (Me is Mn, Ni, or Co) having an olivine structure, x is preferably greater than 0 and less than 1, more preferably greater than or equal to 0.2 and less than or equal to 0.8, or much more preferably greater than or equal to 0.3 and less than or equal to 0.5. In the structural formula LiFeₓMe₁₋ₓPO₄ (Me is Mn, Ni, or Co), as the metal Me, any one of manganese (Mn), nickel (Ni), and cobalt (Co), which are metal atoms each having higher oxidation-reduction potential than iron is contained together with iron. In addition, as the ratio of iron with respect to the metal Me, the value of x in the above structural formula is set to greater than 0 and less than 1, preferably greater than or equal to 0.2 and less than or equal to 0.8, or more preferably greater than or equal to 0.3 and less than or equal to 0.5, whereby any one of manganese (Mn), nickel (Ni), and cobalt (Co) serves as a catalyst and energy density as well as conductivity of the iron phosphate compound increases. As a result, in a lithium-ion secondary battery in which the iron phosphate compound is used for a positive electrode-active material layer, the discharging voltage as well as discharging capacitance can be increased (more specifically, discharging capacitance can be greater than or equal to 150 mAh/g). Further, energy density is obtained by a product of discharging capacitance and discharging voltage; therefore, the energy density of the iron phosphate compound can be increased. More specifically, the energy density can be higher than 500 mWh/g, preferably higher than or equal to 550 mWh/g.

Next, a manufacturing method of the iron phosphate compound having an olivine structure, which contains lithium and a metal Me, will be described.

As examples of a raw material of lithium, lithium carbonate (LiCO₃), lithium hydroxide (Li(OH)), lithium hydroxide hydrate (Li(OH).H₂O), lithium nitrate (LiNO₃), and the like can be given. As examples of a raw material of iron, iron oxalate dihydrate (Fe(COO)₂.2H₂O), iron chloride (FeCl₂), and the like can be given. As examples of a raw material of phosphate, diammonium hydrogen phosphate ((NH₄)₂HPO₄), ammonium dihydrogen phosphate (NH₄H₂PO₄), phosphorus pentoxide (P₂O₅), and the like can be given.

In addition, as examples of a raw material of manganese, manganese carbonate (MnCO₃), manganese chloride tetrahydrate (MnCl₂.4H₂O), and the like can be given. As examples of a raw material of nickel, nickel oxide (NiO), nickel hydroxide (Ni(OH)₂), and the like can be given. As examples of a raw material of cobalt, cobalt carbonate (CoCO₃), cobalt chloride (CoCl₂), and the like can be given.

However, the respective raw materials are not limited to those described above as long as metals such as lithium, iron, manganese, nickel, and cobalt are each contained, and another oxide, carbonate, oxalate, chloride, sulfate, or the like may be used.

Moreover, as a raw material of phosphate, another raw material containing phosphate can be used without limitation to the above raw materials.

In accordance with the stoichiometric proportion of the structural formula of a desired iron phosphate compound, the amounts of the raw materials at which a desired molar ratio can be obtained are each weighed. In the above structural formula, the ratio of lithium, iron, Me, and a phosphate group is 1:x:(1−x):1 (note that x is greater than 0 and less than 1, preferably greater than or equal to 0.2 and less than or equal to 0.8, or more preferably greater than or equal to 0.3 and less than or equal to 0.5), and the amounts of the raw materials are each weighed accurately in accordance with this molar ratio.

The weighed raw materials are put in a ball-mill machine and ground until the raw materials become fine powder (a first grinding step). At this time, it is better to use a ball-mill machine made of a material (e.g., a gate) which prevents other materials from entering the raw materials. When a minute amount of acetone, alcohol, or the like is added together at this time, the raw materials easily come together, and scattering of the powder can be suppressed.

After that, the powder is subjected to a step of applying a first pressure and is thus molded into a pellet state. The pellet is put into a baking furnace, heated, and subjected to a first baking step. Various degassing and thermal decomposition of the raw materials are substantially performed in this step.

When the first baking step is completed, an organic compound such as glucose may be added. When the subsequent steps are performed after glucose is added, carbon supplied from the glucose is supported on the surface of particles of an iron phosphate compound.

Note that in this specification, the state in which the surface of particles of the iron phosphate compound is supported with a carbon material is also described that particles of the iron phosphate compound is coated with carbon.

The thickness of the supported carbon (a carbon layer) is preferably greater than 0 nm and less than or equal to 100 nm, more preferably greater than or equal to 5 nm and less than or equal to 10 nm.

By supporting carbon on the surfaces of particles of the iron phosphate compound, the conductivity of the surfaces of the particles of the iron phosphate compound can be increased. In addition, when the particles of the iron phosphate compound are in contact with each other through carbon supported on the surfaces, the particles of the iron phosphate compound become electrically conductive with each other; thus, the conductivity of a positive electrode active material can be increased.

Note that although glucose is used in this embodiment as a carbon supply source because glucose easily reacts with a phosphate group, cyclic monosaccharide, straight-chain monosaccharide, or polysaccharide which reacts well with a phosphate group may be used instead of glucose.

After that, the pellet is put into the ball-mill machine together with acetone and the mixture is ground again (a second grinding step). Next, the fine powder is molded again into a pellet state, and a second baking step is performed in the baking furnace. By the second baking step, a plurality of particles of the iron phosphate compound containing lithium, iron, Me, and a phosphate group at a ratio of 1:x:(1−x):1 can be formed.

The grain size of the particle of the iron phosphate compound, which is obtained through the second baking step, is greater than or equal to 10 nm and less than or equal to 100 nm, preferably greater than or equal to 20 nm and less than or equal to 60 nm. The particle of the iron phosphate compound is small when the grain size of the particle of the iron phosphate compound is within the above ranges; therefore, lithium ions are easily eliminated; thus, rate characteristics of a lithium-ion secondary battery is improved and charging can be performed in a short time.

The conductivity of the pellet of the obtained iron phosphate compound is preferably greater than or equal to 1×10⁻⁹ S/cm and less than or equal to 6×10⁻⁹ S/cm.

An iron phosphate compound containing lithium and a metal Me, which contains iron, has higher conductivity than a phosphate compound containing lithium and a metal Me, without iron. In addition, when the conductivity of an iron phosphate compound is greater than or equal to 1×10⁻⁹ S/cm, electrons easily transfer in the iron phosphate compound. Due to the transfer of the electrons, lithium ions also easily transfer in the iron phosphate compound.

When lithium ions transfer easily in an iron phosphate compound, the number of lithium ions increases, which are inserted into and eliminated from the iron phosphate compound which functions as a positive electrode active material. In addition, since the oxidation-reduction reaction of a metal Me as well as iron proceeds, discharging capacitance as a lithium-ion secondary battery can be increased.

Moreover, the conductivity of lithium iron phosphate (LiFePO₄) is 7×10⁻⁹ S/cm; therefore, the conductivity of the iron phosphate compound which is obtained in this embodiment is preferably close to that value.

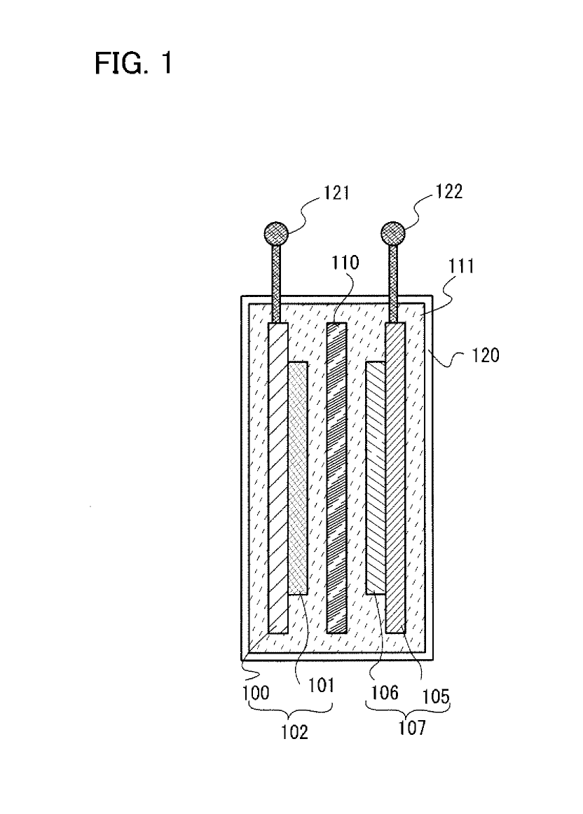

The lithium-ion secondary battery in which the iron phosphate compound obtained through the manufacturing process described above is used as a positive electrode active material will be described below. The schematic structure of the lithium-ion secondary battery is illustrated in FIG. 1.

In a lithium-ion secondary battery illustrated in FIG. 1, a positive electrode 102, a negative electrode 107, and a separator 110 are provided in a housing 120 which is isolated from the outside, and an electrolyte 111 is filled in the housing 120. In addition, the separator 110 is provided between the positive electrode 102 and the negative electrode 107. A first electrode 121 and a second electrode 122 are connected to a positive electrode current collector 100 and a negative electrode current collector 105, respectively, and charging and discharging are performed by the first electrode 121 and the second electrode 122. Moreover, there are certain gaps between a positive electrode-active material layer 101 and the separator 110 and between a negative electrode-active material layer 106 and the separator 110. However, without limitation thereto, the positive electrode-active material layer 101 may be in contact with the separator 110, and the negative electrode-active material layer 106 may be in contact with the separator 110. Further, the lithium-ion secondary battery may be rolled into a cylinder shape with the separator 110 provided between the positive electrode 102 and the negative electrode 107.

The positive electrode-active material layer 101 is formed over the positive electrode current collector 100. The positive electrode-active material layer 101 contains the iron phosphate compound containing lithium and a metal Me, which is manufactured in this embodiment. On the other hand, the negative electrode-active material layer 106 is formed over the negative electrode current collector 105. In this specification, the positive electrode-active material layer 101 and the positive electrode current collector 100 over which the positive electrode-active material layer 101 is formed are collectively referred to as the positive electrode 102. The negative electrode-active material layer 106 and the negative electrode current collector 105 over which the negative electrode-active material layer 106 is formed are collectively referred to as the negative electrode 107.

Note that the “active material” refers to a material that relates to insertion and elimination of ions which function as carriers and does not include a carbon layer including glucose, or the like. Thus, the conductivity of the active material refers to the conductivity of the active material itself and does not refer to the conductivity of an active material including a carbon layer which is formed on a surface thereof. When the positive electrode 102 is formed by a coating method which will be described later, the active material layer including a carbon layer is mixed with another material such as a conduction auxiliary agent, a binder, or a solvent and is formed as the positive electrode-active material layer 101 over the positive electrode current collector 100. Thus, the active material and the positive electrode-active material layer 101 are distinguished.

As the positive electrode current collector 100, a material having high conductivity such as aluminum or stainless steel can be used. The electrode current collector 100 can have a foil shape, a plate shape, a net shape, or the like as appropriate.

As the positive electrode active material, an iron phosphate compound having an olivine structure, which is represented by a structural formula LiFeₓMe₁₋ₓd PO₄ (Me is Mn, Ni, or Co) (x is preferably greater than 0 and less than 1, more preferably greater than or equal to 0.2 and less than or equal to 0.8, or much more preferably greater than or equal to 0.3 and less than or equal to 0.5).

After the second baking step, the obtained iron phosphate compound is ground again (a third grinding step) in the ball-mill machine to obtain fine powder. A conduction auxiliary agent, a binder, or a solvent is mixed into the obtained fine powder to obtain paste.

As the conduction auxiliary agent, a material which is itself an electron conductor and does not cause chemical reaction with other materials in a battery device may be used. For example, carbon-based materials such as graphite, carbon fiber, carbon black, acetylene black, and VGCF (registered trademark); metal materials such as copper, nickel, aluminum, and silver; and powder, fiber, and the like of mixtures thereof can be given. The conduction auxiliary agent is a material that assists conductivity between active materials; it is filled between active materials which are apart and makes conduction between the active materials.

As the binder, a polysaccharide such as starch, polyvinyl alcohol, carboxymethyl cellulose, hydroxypropyl cellulose, regenerated cellulose, or diacetyl cellulose; a thermoplastic resin such as polyvinyl chloride, polyvinyl pyrrolidone, polytetrafluoroethylene, polyvinylide fluoride, polyethylene, or polypropylene; or a polymer with rubber elasticity such as ethylene-propylene-diene monomer (EPDM), sulfonated EPDM, styrene-butadiene rubber, butadiene rubber, fluorine rubber, or polyethylene oxide can be given.

The active material, the conduction auxiliary agent, and the binder are mixed at 80 wt % to 96 wt %, 2 wt % to 10 wt %, and 2 wt % to 10 wt %, respectively, to be 100 wt % in total. Further, an organic solvent, the volume of which is approximately the same as that of the mixture of the active material, the conduction auxiliary agent, and the binder, is mixed therein and processed into a slurry state. Note that an object which is obtained by processing, into a slurry state, a mixture of the active material, the conduction auxiliary agent, the binder, and the organic solvent is referred to as slurry. As the solvent, N-methyl-2-pyrrolidone, lactic acid ester, or the like can be used. The proportions of the active material, the conduction auxiliary agent, and the binder are preferably adjusted as appropriate in such a manner that, for example, when the active material and the conduction auxiliary agent have low adhesiveness at the time of film formation, the amount of binder is increased, and when the resistance of the active material is high, the amount of conduction auxiliary agent is increased.

Here, an aluminum foil is used as the positive electrode current collector 100, and the slurry is dropped thereover and is thinly spread by a casting method. Then, after the slurry is further stretched by a roller press machine and the thickness is formed uniformly, the positive electrode-active material layer 101 is formed over the positive electrode current collector 100 by being subjected to vacuum drying (less than or equal to 10 Pa) or heat drying (at 150° C. to 280° C.). As the thickness of the positive electrode-active material layer 101, a desired thickness is selected from the range of 20 μm to 100 μm. It is preferable to adjust the thickness of the positive electrode-active material layer 101 as appropriate so that cracks and separation do not occur. Further, it is preferable that cracks and separation be made not to occur on the positive electrode-active material layer 101 not only when a lithium-ion secondary battery is flat but also rolled into a cylinder shape, though it depends on forms of a lithium-ion secondary battery.

As the negative electrode current collector 105, a material having high conductivity such as copper, stainless steel, iron, or nickel can be used.

As the negative electrode-active material layer 106, lithium, aluminum, graphite, silicon, germanium, or the like is used. The negative electrode-active material layer 106 may be formed over the negative electrode current collector 105 by a coating method, a sputtering method, an evaporation method, or the like. Alternatively, each material may be used alone as the negative electrode-active material layer 106. The theoretical lithium occlusion capacity is larger in germanium, silicon, lithium, and aluminum than graphite. When the occlusion capacity is large, charging and discharging can be performed sufficiently even in a small area and a function as a negative electrode can be obtained; therefore, cost reduction and miniaturization of a lithium-ion secondary battery can be realized. However, in the case of silicon or the like, the volume is increased approximately fourth times as larger as the volume before lithium occlusion; therefore, it is necessary to pay attention to the risk of explosion, the probability that the material itself gets vulnerable, and the like.

As the electrolyte, an electrolyte solution that is an electrolyte in a liquid state, a solid electrolyte that is an electrolyte in a solid state may be used. The electrolyte solution contains an alkali metal ion or an alkaline earth metal ion as a carrier ion, and this carrier ion is responsible for electric conduction. Examples of the alkali metal ion include a lithium ion, a sodium ion, and potassium ion. Examples of the alkaline earth metal ion include a calcium ion, a strontium ion, and a barium ion.

The electrolyte 111 includes, for example, a solvent and a lithium salt or a sodium salt dissolved in the solvent. Examples of the lithium salt include lithium chloride (LiCl), lithium fluoride (LiF), lithium perchlorate (LiClO₄), lithium tetrafluoroborate (LiBF₄), LiAsF₆, LiPF₆, and Li(C₂F₅SO₂)₂N. Examples of the sodium salt include sodium chloride (NaCl), sodium fluoride (NaF), sodium perchlorate (NaClO₄), and sodium fluoroborate (NaBF₄).

Examples of the solvent for the electrolyte 111 include cyclic carbonates (e.g., ethylene carbonate (hereinafter abbreviated to EC), propylene carbonate (PC), butylene carbonate (BC), and vinylene carbonate (VC)); acyclic carbonates (e.g., dimethyl carbonate (DMC), diethyl carbonate (DEC), ethylmethyl carbonate (EMC), methylpropyl carbonate (MPC), methylisobutyl carbonate (MIBC), and dipropyl carbonate (DPC)); aliphatic carboxylic acid esters (e.g., methyl formate, methyl acetate, methyl propionate, and ethyl propionate); acyclic ethers (e.g., 1,2-dimethoxyethane (DME), 1,2-diethoxyethane (DEE), ethoxymethoxy ethane (EME), and γ-lactones such as γ-butyrolactone); cyclic ethers (e.g., tetrahydrofuran and 2-methyltetrahydrofuran); cyclic sulfones (e.g., sulfolane); alkyl phosphate ester (e.g., dimethylsulfoxide and 1,3-dioxolane, and trimethyl phosphate, triethyl phosphate, and trioctyl phosphate); and fluorides thereof. All of the above solvents can be used either alone or in combination as the electrolyte 111.

As the separator 110, paper; nonwoven fabric; a glass fiber; a synthetic fiber such as nylon (polyamide), vinylon (also called vinalon) (a polyvinyl alcohol based fiber), polyester, acrylic, polyolefin, or polyurethane; or the like may be used. However, a material which does not dissolve in the electrolyte 111 described above should be selected.

More specific examples of the materials for the separator 110 are high-molecular compounds based on fluorine-based polymer, polyether such as polyethylene oxide and polypropylene oxide, polyolefin such as polyethylene and polypropylene, polyacrylonitrile, polyvinylidene chloride, polymethyl methacrylate, polymethylacrylate, polyvinyl alcohol, polymethacrylonitrile, polyvinyl acetate, polyvinylpyrrolidone, polyethyleneimine, polybutadiene, polystyrene, polyisoprene, and polyurethane; derivatives thereof; cellulose; paper; and nonwoven fabric, all of which can be used either alone or in a combination.

When charging of the lithium-ion secondary battery described above is performed, a positive electrode terminal is connected to the first electrode 121 and a negative electrode terminal is connected to the second electrode 122. An electron is taken away from the positive electrode 102 through the first electrode 121 and transferred to the negative electrode 107 through the second electrode 122. In addition, a lithium ion is eluted from the active material in the positive electrode-active material layer 101 from the positive electrode, reaches the negative electrode 107 through the separator 110, and is taken in the active material in the negative electrode-active material layer 106. The lithium ion and the electron are aggregated in this region and are occluded in the negative electrode-active material layer 106. At the same time, in the positive electrode-active material layer 101, an electron is released outside from the active material, and oxidation reaction between iron and the metal Me contained in the active material is generated.

At the time of discharging, in the negative electrode 107, the negative electrode-active material layer 106 releases lithium as an ion, and an electron is transferred to the second electrode 122. The lithium ion passes through the separator 110, reaches the positive electrode-active material layer 101, and is taken in the active material in the positive electrode-active material layer 101. At that time, the electron from the negative electrode 107 also reaches the positive electrode 102, and reduction reaction between iron and the metal Me is generated.

A lithium-ion secondary battery which is manufactured as described above includes an iron phosphate compound having an olivine structure, which contains lithium and a metal Me, as a positive electrode active material. The capacitance per unit weight of such an active material is greater than or equal to 150 mAh/g. On the other hand, when lithium iron phosphate (LiFePO₄) which will be described later is used as a positive electrode active material, the capacitance per unit weight of the active material of the lithium-ion secondary battery is 160 mAh/g.

Therefore, the discharging capacitance of the lithium-ion secondary battery obtained in this embodiment, which includes an iron phosphate compound having an olivine structure, which contains lithium and a metal Me, as a positive electrode active material is as high as that of the lithium-ion secondary battery which includes lithium iron phosphate (LiFePO₄) as a positive electrode active material.

However, the lithium-ion secondary battery which includes lithium iron phosphate (LiFePO₄) as a positive electrode active material as described above has low discharging voltage and low energy density.

On the other hand, the active material of the lithium-ion secondary battery obtained in this embodiment, which includes an iron phosphate compound having an olivine structure, which contains lithium and a metal Me, as a positive electrode active material has high energy density: energy density per unit weight is higher than 500 mWh/g, preferably higher than or equal to 550 mWh/g.

In the iron phosphate compound obtained in this embodiment, which contains lithium and a metal Me, atoms of the metal Me having higher oxidation-reduction potential than iron is substituted for part of the iron atoms. With this oxidation-reduction reaction of the metal Me, the energy density of the iron phosphate compound increases. Moreover, the discharging voltage and the energy density of the lithium-ion secondary battery which includes the iron phosphate compound as a positive electrode active material increases.

As described above, in an iron phosphate compound having an olivine structure, which contains lithium and a metal Me, a positive electrode active material with high discharging capacitance and high energy density can be obtained by substituting atoms of the metal Me having higher oxidation-reduction potential than iron for part of the iron atoms. Further, by obtainment of such a positive electrode active material, a power storage device with high discharging capacitance (specifically, greater than or equal to 150 mAh/g), high discharging voltage, and high energy density (specifically, higher than 500 mWh/g, preferably higher than or equal to 550 mWh/g) can be obtained.

### Example 1

In this example, a manufacturing process of lithium iron manganese phosphate (LiFeₓMn₁₋ₓPO₄) (x is greater than 0 and less than 1) having an olivine structure and evaluation results of the property of the manufactured lithium iron manganese phosphate (LiFeₓMn₁₋ₓPO₄) (x is greater than 0 and less than 1) having an olivine structure will be described. In addition, evaluation results of the property of a lithium-ion secondary battery when the lithium iron manganese phosphate (LiFeₓMn₁₋ₓPO₄) is used as a positive electrode active material will be described.

First, a manufacturing process of the lithium iron manganese phosphate (LiFeₓMn₁₋ₓPO₄) will be described.

Lithium carbonate (LiCO₃) was used as a raw material of lithium, iron oxalate dihydrate (Fe(COO)₂.2H₂O) was used as a raw material of iron, manganese carbonate (MnCO₃) was used as a raw material of manganese, and ammonium dihydrogen phosphate ((NH₄)₂HPO₄) was used as a raw material of phosphate.

In accordance with the stoichiometric proportion of the structural formula of lithium iron manganese phosphate (LiFeₓMn₁₋ₓPO₄), the amounts of the raw materials at which a desired molar ratio can be obtained were each weighed. In the above structural formula, the rate of lithium, iron, manganese, and a phosphate group was 1:x:(1−x):1, and the amounts of the raw materials were each weighed in accordance with this molar ratio.

Embodiment 1 was to be referred to the manufacturing process of the lithium iron manganese phosphate (LiFeₓMn₁₋ₓPO₄). Note that the first pressure described in Embodiment 1 is 1.96×10⁷ Pa to 4.90×10⁷ Pa (200 kgf/cm² to 500 kgf/cm²), preferably 3.82×10⁷ Pa (400 kgf/cm²).

In the first baking step described in Embodiment 1, heating treatment was performed at 350° C. in the furnace under a nitrogen atmosphere for 10 hours.

In the second baking step described in Embodiment 1, heating treatment was performed at 600° C. in the furnace under a nitrogen atmosphere for 10 hours.

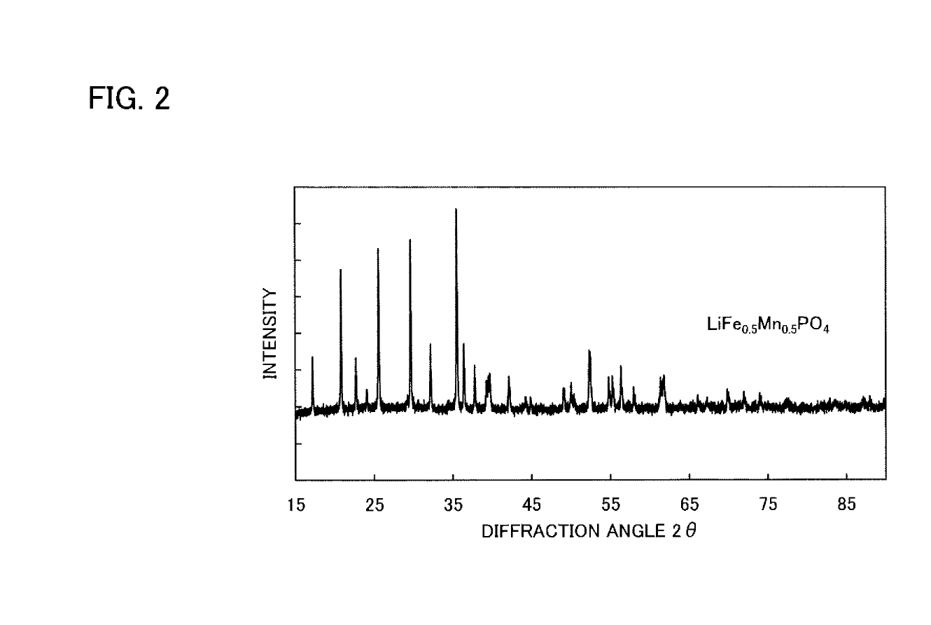

FIG. 2 shows, by an X-ray diffraction method, measurement results of the crystal structure of the obtained lithium iron manganese phosphate, where x is 0.5, that is, lithium iron manganese phosphate represented by a structural formula LiFe_{0.5}Mn_{0.5}PO₄. It is found from FIG. 2 that the obtained lithium iron manganese phosphate (LiFe_{0.5}Mn_{0.5}PO₄) has an olivine structure in which the space group is pnma (62).

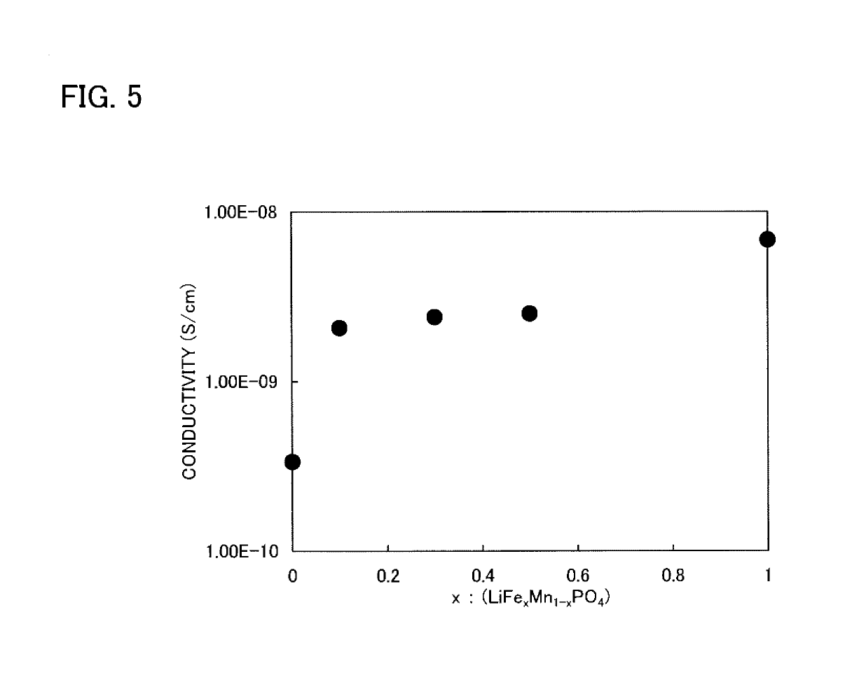

In addition, lithium iron manganese phosphate (LiFeₓMn₁₋ₓPO₄) having an olivine structure, where the value of x is changed (x=0, 0.1, 0.3, 0.5, and 1) is molded into a pellet state as described in Embodiment 1. FIG. 5 shows the conductivity of the obtained pellets. Note that FIG. 5 shows the conductivity of the lithium iron manganese phosphate which is obtained by performing the steps up to the second baking step without supporting a carbon layer (without performing carbon coating).

In Embodiment 1, it is described that the conductivity of the iron phosphate compound is preferably greater than or equal to 1×10⁻⁹ S/cm and less than or equal to 6×10⁻⁹ S/cm. According to FIG. 5, in the lithium iron manganese phosphate (LiFeₓMn₁₋ₓPO₄) manufactured in this example, the conductivity is preferably greater than or equal to 1×10⁻⁹ S/cm and less than or equal to 6×10⁻⁹ S/cm in the range of x which is greater than 0 and less than 1.

An iron phosphate compound containing lithium and a metal Me, which contains iron, has higher conductivity than lithium manganese phosphate (LiMnPO₄) where x is 1, and electrons easily transfer in the iron phosphate compound. Due to the transfer of the electrons, lithium ions also easily transfer in the iron phosphate compound.

When lithium ions transfer easily in an iron phosphate compound, the number of lithium ions increases, which are inserted into and eliminated from the iron phosphate compound which functions as a positive electrode active material. In addition, since the oxidation-reduction reaction of a metal Me as well as iron proceeds, discharging capacitance as a lithium-ion secondary battery can be increased.

Next, aluminum is used for the positive electrode current collector 100, and the positive electrode-active material layer 101 containing lithium iron manganese phosphate (LiFe_{0.5}Mn_{0.5}PO₄) is formed over the positive electrode current collector 100. For the positive electrode-active material layer 101, acetylene black was used as the conduction auxiliary agent and polytetrafluoroethylene (PTFE) was used as the binder. A lithium metal was used for the negative electrode 107.

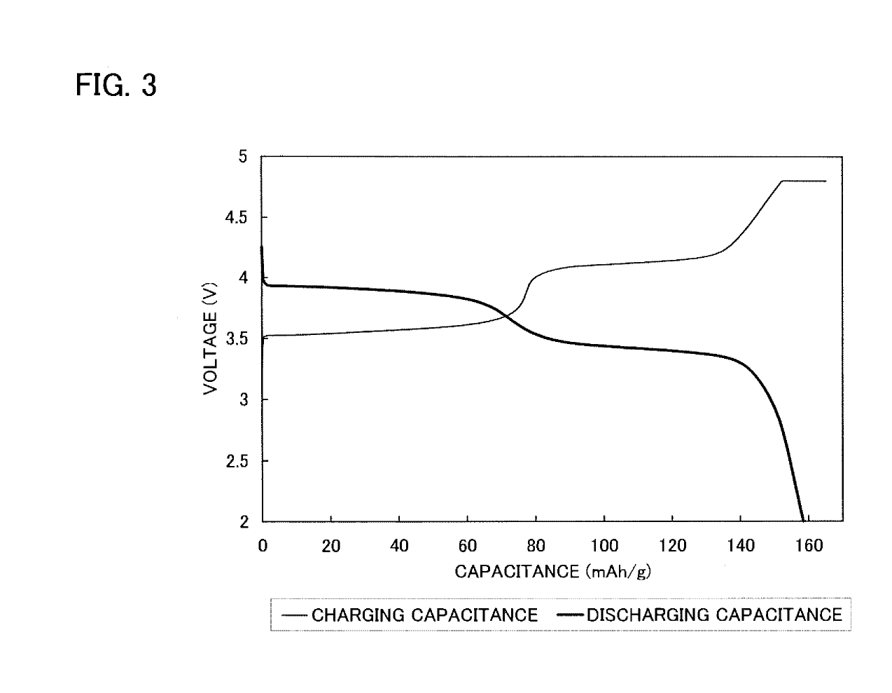

FIG. 3 shows electric characteristics of a lithium-ion secondary battery in which the lithium iron manganese phosphate (LiFe_{0.5}Mn_{0.5}PO₄) obtained as described above is used as a positive electrode active material.

From FIG. 3, 3.5 V (a first plane portion) and 4.2 V (a second plane portion) are shown as the voltages at the time of charging. It is known that a standard electrode potential when a lithium ion is changed to a lithium metal is −3.05 V, a standard electrode potential when trivalent iron is changed to bivalent iron is +0.77 V, and a standard electrode potential when trivalent manganese is changed to bivalent manganese is +1.51 V.

When a potential difference is obtained from the above, a voltage between lithium and iron can be calculated as 3.8 V, and a voltage between lithium and manganese can be calculated as 4.5 V. Thus, the voltage at 3.5 V in the charging curve of FIG. 3 is derived from a lithium discharge mechanism of lithium iron phosphate, and the voltage at 4.2 V in the charging curve of FIG. 3 is derived from a lithium discharge mechanism of lithium manganese phosphate.

On the other hand, in FIG. 3, 3.9 V (a third plane portion) and 3.4 V (a fourth plane portion) are obtained as the voltages at the time of discharging.

In FIG. 3, the discharging capacitance of the point at which the voltage is changed from 3.9 V to 3.4 V is 70 mAh/g to 80 mAh/g and is the half of the total maximum discharging capacitance. Accordingly, it is found that the discharging capacitance depends on a ratio between iron and manganese in the active material.

Further, it is shown from FIG. 3 that the discharging capacitance per unit weight of the active material is 158 mAh/g. This discharging capacitance is comparable to the theoretical capacitance of lithium iron phosphate having an olivine structure, which is 160 mAh/g to 170 mAh/g. The theoretical capacitance of lithium iron phosphate having an olivine structure is a capacitance obtained by calculation based on a crystal lattice of the lithium iron phosphate having an olivine structure.

It is shown from FIG. 3 that high discharging capacitance is obtained in the lithium-ion secondary battery in which the lithium iron manganese phosphate manufactured by this example is used as a positive electrode active material.

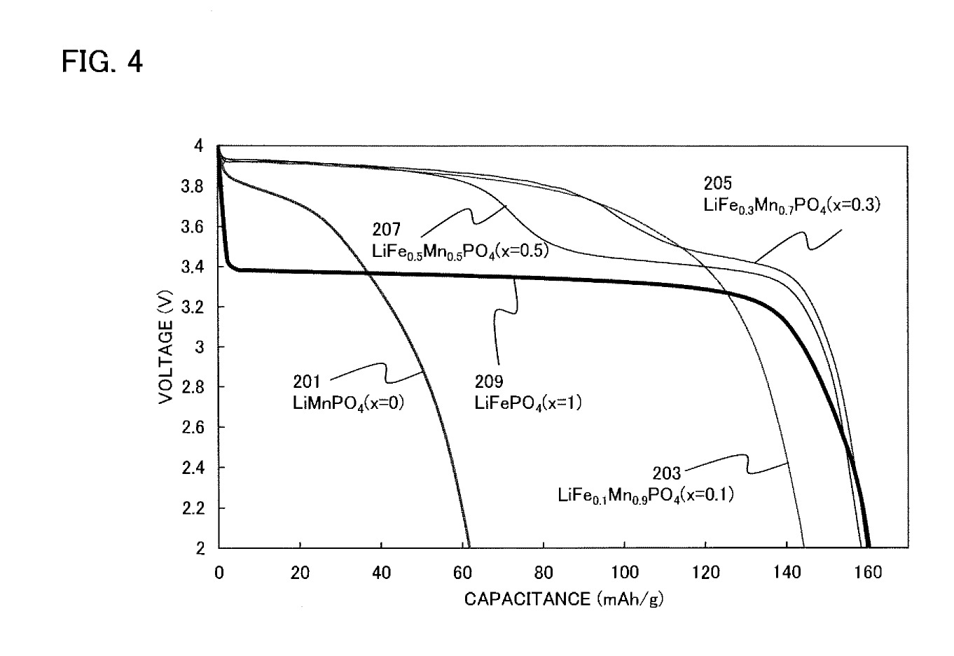

FIG. 4 shows discharging curves of lithium-ion secondary batteries in which the respective values of x in lithium iron manganese phosphate (LiFeₓMn₁₋ₓPO₄) having an olivine structure are changed (x=0, 0.1, 0.3, 0.5, and 1). The horizontal axis represents discharging capacitance, and the vertical axis represents discharging voltage. A curve 201 denotes a discharging curve where x is 0 (LiMnPO₄), a curve 203 denotes a discharging curve where x is 0.1 (LiFe_{0.1}Mn_{0.9}PO₄), a curve 205 denotes a discharging curve where x is 0.3 (LiFe_{0.3}Mn_{0.7}PO₄), a curve 207 denotes a discharging curve where x is 0.5 (LiFe_{0.5}Mn_{0.5}PO₄), and a curve 209 denotes a discharging curve where x is 1 (LiFePO₄).

When x is 0 in FIG. 4, that is, in the case of lithium manganese phosphate (LiMnPO₄), although the discharging capacitance is low, the output voltage is high. On the other hand, when x is 1, that is, in the case of lithium iron phosphate (LiFePO₄), although the discharging capacitance is high, the output voltage is low.

When x is the value between 0 and 1, particularly when x is 0.3 (LiFe_{0.3}Mn_{0.7}PO₄) and 0.5 (LiFe_{0.5}Mn_{0.5}PO₄), the value of the discharging capacitance is substantially the same as that of the case where only lithium iron phosphate is used. This is because lithium iron manganese phosphate (LiFeₓMn₁₋ₓPO₄) as well as lithium iron phosphate (LiFePO₄) includes iron and thus has high conductivity and therefore electrons transfer easily therein as compared to lithium manganese phosphate (LiMnPO₄). Accordingly, oxidation reaction of iron, oxidation reaction of manganese, and reduction reaction of lithium ions are promoted; thus, lithium ions transfer easily.

Moreover, in lithium iron manganese phosphate (LiFeₓMn₁₋ₓPO₄) having an olivine structure, the manganese atoms are substituted for part of the iron atoms of lithium iron phosphate. Accordingly, when lithium ions transfer easily, the lithium ions can easily transfer to a portion including the manganese atoms. As a result, the number of lithium ions inserted into entire lithium iron manganese phosphate increases. Therefore, the discharging capacitance can be increased.

Further, in the lithium iron manganese phosphate obtained in this example, manganese atoms having higher oxidation-reduction potential than iron is substituted for part of the iron atoms of lithium iron phosphate. With this oxidation-reduction reaction of the manganese atom, the discharging voltage and the energy density of the lithium iron manganese phosphate can be increased as compared to lithium iron phosphate (LiFePO₄), and high energy density is obtained.

As described above, with the use of lithium iron manganese phosphate (LiFeₓMn₁₋ₓPO₄) having an olivine structure as an active material, a positive electrode active material with high discharging capacitance and high energy density can be obtained. Further, by obtainment of such a positive electrode active material, a lithium-ion secondary battery with high discharging capacitance, high discharging voltage, and high energy density can be obtained.

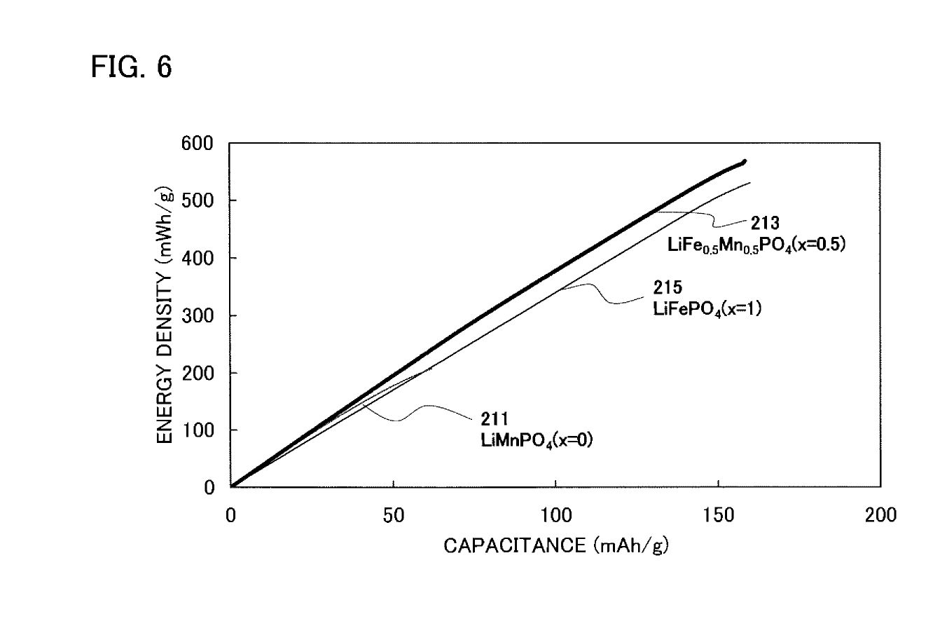

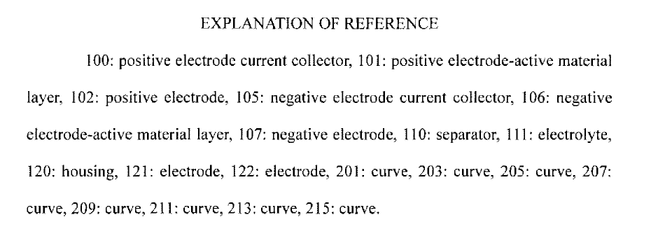

Next, FIG. 6 shows energy densities of a structural formula LiFeₓMn₁₋ₓPO₄, when x is 0 (LiMnPO₄), when x is 0.5 (LiFe_{0.5}Mn_{0.5}PO₄), and when x is 1 (LiFePO₄). The energy densities shown in FIG. 6 are obtained by integrating the capacitance in the horizontal axis of FIG. 4 by the voltage in the vertical axis thereof. Note that in FIG. 6, a curve 211 denotes the energy density when x is 0 (LiMnPO₄), a curve 213 denotes the energy density when x is 0.5 (LiFe_{0.5}Mn_{0.5}PO₄), and a curve 215 denotes the energy density when x is 1 (LiFePO₄).

As shown in FIG. 6, when the lithium iron manganese phosphate (LiFe_{0.5}Mn_{0.5}PO₄) where x is 0.5 is used as a positive electrode active material, the energy density exceeds 550 mW/g and reaches 570 mW/g. Such a high energy density is obtained because a manganese atom having high oxidation-reduction potential is contained therein.

As described above, with the use of lithium iron manganese phosphate having an olivine structure, a positive electrode active material with high discharging capacitance and high energy density can be obtained. Further, by obtainment of such a positive electrode active material, a lithium-ion secondary battery with high discharging capacitance (specifically, greater than or equal to 150 mAh/g), high discharging voltage, and high energy density (specifically, higher than 500 mWh/g, preferably higher than or equal to 550 mWh/g) can be obtained.

This application is based on Japanese Patent Application serial No. 2010-073404 filed with the Japan Patent Office on Mar. 26, 2010 and Japanese Patent Application serial No. 2010-073727 filed with the Japan Patent Office on Mar. 26, 2010, the entire contents of which are hereby incorporated by reference.

1. A power storage device comprising:
a positive electrode including a positive electrode active material having an olivine structure which is represented by a structural formula LiFeMe₁₋ₓPO₄ (Me=Mn, Ni, or Co) (x is greater than 0 and less than 1) and which has conductivity of greater than or equal to 1×10⁻⁹ S/cm and less than or equal to 6×10⁻⁹ S/cm.

2. The power storage device according to claim 1, wherein the positive electrode active material has discharging capacitance of greater than or equal to 150 mAh/g and energy density of higher than or equal to 550 m Wh/g.

3. The power storage device according to claim 1, wherein the positive electrode active material comprises a plurality of particles, grain sizes each of which is greater than or equal to 10 nm and less than or equal to 100 nm.

4. The power storage device according to claim 3, wherein each of the particles is covered with a carbon layer, a thickness of which is greater than 0 and less than or equal to 100 nm.

5. A power storage device comprising:
a positive electrode comprising a positive electrode current collector and a positive electrode-active material layer provided over the positive electrode current collector, the positive electrode-active material layer including a positive electrode active material having an olivine structure which is represented by a structural formula LiFeMe₁₋ₓPO₄ (Me=Mn, Ni, or Co) (x is greater than 0 and less than 1) and which has conductivity of greater than or equal to 1×10⁻⁹ S/cm and less than or equal to 6×10⁻⁹ S/cm; and
a negative electrode which faces the positive electrode through an electrolyte.

6. The power storage device according to claim 5, wherein the positive electrode active material has discharging capacitance of greater than or equal to 150 mAh/g and energy density of higher than or equal to 550 m Wh/g.

7. The power storage device according to claim 5, wherein the positive electrode active material comprises a plurality of particles, grain sizes each of which is greater than or equal to 10 nm and less than or equal to 100 nm.

8. The power storage device according to claim 7, wherein each of the particles is covered with a carbon layer, a thickness of which is greater than 0 and less than or equal to 100 nm.

9. The power storage device according to claim 5, wherein the negative electrode contains one or more of graphite, silicon, and aluminum.

10. The power storage device according to claim 5, wherein the electrolyte is an electrolyte solution containing a lithium ion.

11. A power storage device comprising:
a positive electrode comprising a positive electrode current collector and a positive electrode-active material layer provided over the positive electrode current collector, the positive electrode-active material layer including a positive electrode active material having an olivine structure which is represented by a structural formula LiFeₓMe₁₋ₓPO₄ (Me=Mn, Ni, or Co) (x is greater than 0 and less than 1); and
a negative electrode which faces the positive electrode through an electrolyte.
wherein discharging capacitance is greater than or equal to 150 mAh/g and energy density is higher than 500 mWh/g.

12. The power storage device according to claim 11, wherein the positive electrode active material comprises a plurality of particles, grain sizes each of which is greater than or equal to 10 nm and less than or equal to 100 nm.

13. The power storage device according to claim 12, wherein each of the particles is covered with a carbon layer, a thickness of which is greater than 0 and less than or equal to 100 nm.

14. The power storage device according to claim 11, wherein the negative electrode contains one or more of graphite, silicon, and aluminum.

15. The power storage device according to claim 11, wherein the electrolyte is an electrolyte solution containing a lithium ion.

16. A power storage device comprising:
a positive electrode comprising a positive electrode current collector and a positive electrode-active material layer provided over the positive electrode current collector, the positive electrode-active material layer including a positive electrode active material having an olivine structure which is represented by a structural formula LiFeₓMe₁₋ₓPO₄ (Me=Mn, Ni, or Co) (x is greater than 0 and less than 1); and
a negative electrode which faces the positive electrode through an electrolyte,
wherein discharging capacitance is greater than or equal to 150 mAh/g and energy density is higher than 550 mWh/g.

17. The power storage device according to claim 16, wherein the positive electrode active material comprises a plurality of particles, grain sizes each of which is greater than or equal to 10 nm and less than or equal to 100 nm.

18. The power storage device according to claim 17, wherein each of the particles is covered with a carbon layer, a thickness of which is greater than 0 and less than or equal to 100 nm.

19. The power storage device according to claim 16, wherein the negative electrode contains one or more of graphite, silicon, and aluminum.

20. The power storage device according to claim 16, wherein the electrolyte is an electrolyte solution containing a lithium ion.
